(19) United States
(12) Patent Application Publication
(10) Pub. No.: US 2006/0070997 A1
(43) Pub. Date: Apr. 6, 2006

(54) Device and method for sterilisation, filling and sealing of a package

(76) Inventor: Johan B. Sjoholm, Lund (SE)

Correspondence Address: Gauthier & Connors LLP;Suite 2300, 225 Franklin Street, Boston, MA, 02110, US

(21) Appl. No.: 11/236,887

(22) Filed: Sep. 28, 2005

Related U.S. Application Data
(63) Continuation of application No. PCT/SE04/00508, filed on Apr. 2, 2004.

(30) Foreign Application Priority Data
Apr. 4, 2003 (SE) 0300990-9

(51) Int. Cl. B65B 55/04; B65B 7/28; B65D 51/18; B67B 1/03

(52) U.S. Cl. 220/254.7; 53/426; 53/471; 220/254.1; 220/259.3

(57) ABSTRACT

The present invention relates to a device for sealing a package, and a method for sterilization, filling and sealing of the package. The device comprises a peripheral part adapted to be mechanically connected to the package round an opening in the package, said peripheral part comprising a passage for internal sterilization of the package and filling of the package with a product after connecting the peripheral part t the package. The device further comprises a separate upper part for permanent gas-tight sealing of the passage, said upper part being adapted to fit tightly against and form a unit with the peripheral part.

### FIELD OF THE INVENTION

The present invention relates to a device for sealing a package, use of the device for indicating which product the package holds, and a method for sterilisation, filling and sealing of the package.

### BACKGROUND ART

What is referred to as aseptic filling of food packages with foods, such as dairy products, juices etc, is complicated due to great cleanliness requirements for both package material and filling equipment. Normally, a relative risk in the range of one to ten thousand is acceptable, which means that of ten thousand packages that are being filled, at most one package is allowed to be contaminated by, for example, microorganisms.

A known package type and principle for aseptic filling is represented by the system Tetra Brik Aseptic® which is sold by Tetra Pak. In this system, a package material is sterilised by being exposed to H₂O₂ and hot air. This is done when the package material has been formed to a tube and is ready for filling. Before the sterilising phase, extensive washing with, for instance, acid and lye must be performed.

However, the beverage market seeks to attain health, convenience and innovation. In the dairy sector new types of products are introduced all the time. Therefore differentiation of products including packages is most important for a product to survive on the market. As a result aseptic plastic bottles, above all PET bottles, are in increasing demand. PET bottles are gas-tight and easy to open and close and thus satisfy current consumer requirements for health and convenience. If the opening of the bottle is kept constant, the shape and volume of the bottle can easily be varied, which allows differentiation.

Aseptic bottling machines are very bulky, complicated and expensive due to the high sanitary requirements that are placed on the package material. The bottles and caps must be rinsed, disinfected and sterilised. Due to the complexity, the machine is installed in separate clean rooms. The operator can either move around in this clean room or merely by means of flexible gloves use his arms to touch the necessary functions in the clean room or in the machine. If a stoppage occurs in an aseptic bottling machine and lasts for quite a while, resterilisation must be performed. Every unnecessary stoppage or any other interruption causes an increased risk of contamination and increased production costs and should thus be prevented as far as possible.

U.S. Pat. No 5,928,607 discloses a method and a device for sterilising a bottle before filling the bottle with a product. In the described device, UV radiation is used to transform oxygen to ozone at the filling station. The ozone flows into the bottle and thus sterilises it. The bottle is then immediately filled with a desired product and sealed. An excimer lamp is used as UV radiation source.

The device disclosed in U.S. Pat. No. 5,928,607 has the advantage that it need not be installed in a sterile clean room. Instead the clean room is reduced to comprise only the interior of the bottle which is sterilised with ozone immediately before filling, so that the bottle is not allowed to be contaminated between sterilisation and filling. A drawback of this device and method is, however, that the ozone can react with the product when the ozone is extracted from the product. Thus the quality of the product may be deteriorated, which for instance may result in the product getting an unpleasant taste. Also remaining ozone residues in the bottle after filling can react with the product and result themselves in a certain unpleasant taste. After a while the ozone residues decompose into oxygen. If the product contains, for instance, fatty acids that turn rancid by oxygen, such ozone residues are devastating to the shelf-life of the product.

After filling a package with a product, the package is to be sealed. Since also sealing is a technically complicated process, the filled package is usually conveyed to a separate sealing machine which puts a threaded screw stopper or a cap on the package if it is a bottle and applies a lid by bending or shrinking if the package is a can. Also in these cases it is difficult to provide sterile environmental conditions at a reasonable cost. Sealing must be sterile and the filled package should not be allowed to be contaminated between filling and sealing.

U.S. Pat. No. 5,860,461 discloses a method for aseptic filling of a bottle, or a can, in which a separate mechanical seal is used to fill and seal the bottle, in addition to a manual seal that is intended to be handled by the consumer. The mechanical seal is easy to apply to the bottle and thus is said to reduce the risk of contamination and the technical complexity in sealing.

In some of the variants described, the mechanical seal can be incorporated in an extra opening in the wall of the bottle, in addition to the ordinary opening that is used by the consumer. The mechanical seal and the extra opening are only intended for sterilisation and filling of the bottle, and thus add to additional production costs and an increased risk of contamination of the product unless the final seal of the extra opening is one hundred percent tight. Moreover the bottle is aesthetically affected by the extra opening and the seal.

A further variant of the mechanical seal as shown in U.S. Pat. No. 5,860,661 is inserted in the ordinary opening before filling, after which a manual seal, such as a screw stopper or a cap, is put on top of the mechanical seal. In this case the mechanical seal is still left in the opening of the bottle when the bottle reaches the consumer, and must thus be removed by the consumer or be provided with hooks or the like so as to accompany the manual seal when this is removed from the bottle.

In one more variant disclosed in U.S. Pat. No. 5,860,461, the mechanical seal consists of a tubular part of the manual seal, said tubular part being pressed together and thus closed after filling of the bottle. This variant of a mechanical seal thus projects from the manual seal in a manner which, inter alia, deteriorates the stackability of the bottle.

### SUMMARY OF THE INVENTION

An object of the present invention is to provide an improved method for sterilisation of a package.

Another object of the invention is to provide an alternative device for sealing a package, said device allowing improved sterilisation of the package.

To achieve these and other objects, a device for sealing a package is provided, as defined in claim 1, a method for sterilisation, filling and sealing of a package, as defined in claim 10, and use of a device according to claim 1, as defined in claim 22. Preferred embodiments of the present invention are defined in the dependent claims.

More specifically, according to one aspect of the present invention a device for sealing a package comprises a peripheral part adapted to be mechanically connected to the package round an opening in the package, said peripheral part comprising a passage for internal sterilisation of the package and filling of the package with a product after connecting the peripheral part to the package. The inventive device further comprises a separate upper part for permanent gas-tight sealing of the passage, said upper part being adapted to fit tightly against and form a unit with the peripheral part.

By “unit” is here meant something that constitutes a single physical object and that is not intended to be divided into two or more separate objects or parts. Preferably the surface of the peripheral part evenly passes into the surface of the upper part, thus preventing sharp edges or joints between these parts.

With a device according to the present invention, improved sterilisation of a package can be provided by said peripheral part having a passage that allows internal sterilisation of the package and filling of the package with a product after connecting the peripheral part to the package. Thus, simultaneous sterilisation of both the interior of the package and the interior of the peripheral part of the sealing device can be performed using, for example, ozone, after which the package is filled and given a final seal in the form of said separate upper part. The risk of contamination and the technical complexity in the final sealing can thus be reduced by the separate upper part being designed to be applied in a simple way by, for instance, being pressed together with the peripheral part which is already positioned on the package.

Since the peripheral part is mechanically connected to the package, this seal can be used by the consumer to open and reclose the package.

The inventive device also solves the above problems with the different variants of a mechanical seal as disclosed in U.S. Pat. No. 5,860,461.

First, no extra opening is required to fill the package since the passage in the peripheral part of the inventive device is used for this purpose. Instead of the mechanical seal according to U.S. Pat. No. 5,860,461, a temporary seal can be used, which can be made still simpler as part of the sterilising and/or filling machine or in the form of, for example, a foil matching the peripheral part of the device.

Second, no separate mechanical seal is left in the opening of the package that must be removed by the consumer. If a foil is used for temporary sealing, this may, however, be left together with peripheral part of the device just under said upper part without being a nuisance to the consumer.

Third, problems with reduced stackability and deteriorated appearance of the finished package as a whole can be avoided by the present invention since the final seal is established by said upper part that forms a unit with the peripheral part. The upper part and the peripheral part can together form, for instance, the shape of a conventional screw stopper for a bottle where the peripheral part comprises the threads of the screw stopper.

In one embodiment of the present invention, said upper part is coloured and/or shaped to facilitate recognition of said product among other products in similar packages. The market today requires different colours of seals, such as screw stops, caps etc, in order to allow differentiation of packaged products. Seals in different colours result in a large amount of manual handling, which in turn has a negative sanitary effect. In this embodiment of the invention, differentiation in terms of colour and shape can be provided by only the upper part of the sealing device being changed. The manual handling can be reduced, inter alia, by the complexity in the final sealing being reduced. Instead of final sealing taking place by, for example, a conventional screw stopper being put on the package using a turning device and other mechanically complicated equipment in a clean room environment, in which case the complicated equipment is difficult to keep sterile and operating troubles easily may arise, the final sealing according to this embodiment can take place by the upper part of the device being easily pressed together with the peripheral part which is already fixed to the package. Upper parts, which advantageously are symmetrically formed, can easily be fed in tubes to the “pressing-together device”, which need not be very complicated and thus is more reliable and easier to keep sterile. The peripheral part, which for instance may constitute “the threaded part” of an ordinary screw stopper, can be screwed onto the package outside the clean room area by means of equipment that does not have to satisfy the same sterility requirements.

In one embodiment of the invention, the package is a bottle. In another embodiment, the package is a can. However, the package could be any type of package, for instance also a cardboard box or a bag.

In one embodiment, the peripheral part may comprise a cylindrical part for surrounding an outer partial surface of said package round said opening. The cylindrical part may be, for example, the “side part” of a stopper or cap.

In another embodiment, said peripheral part comprises threads. A typical example of such a peripheral part is the threaded side part of a screw stopper. In yet another embodiment, the peripheral part comprises a snap means, i.e. a means by which the peripheral part can be fixed round the opening in the package by “snapping” or hooking into the package.

In another embodiment, said peripheral part comprises an upper side for said package, in which upper side a passage is formed for internal sterilisation and filling of the package. Such an upper side can typically be the “lid” for an aluminium can for example.

In one embodiment of the invention, said peripheral part is form-fit so as to fit tightly against a closing means for temporary partial closing of said passage during said internal sterilisation of the package. By this form-fit to an external closing means, pollutants coming from the outside can as far as possible be prevented from penetrating into the package during the sterilising phase. The temporary closing means covers the passage “partially” in the sense that there should still be one or more openings, for instance, for sterilising gas to enter or leave. Such a temporary closing means can also be used during the filling phase.

In a special embodiment, said peripheral part comprises a penetratable foil arranged over said passage. The penetratable foil can be very easy to manufacture and apply and functions as the above-mentioned temporary closing means by covering the passage of the peripheral part. When, for example, sterilising gas is to be supplied to the package, a supply tube can be inserted through the penetratable foil, the passage otherwise still being essentially completely covered by the foil.

In one embodiment of the invention, said upper part is made of the same base material as said peripheral part, so that, for example, welding together of the different parts is facilitated.

According to another aspect of the present invention a method for sterilisation, filling and sealing of a package comprises the steps of connecting a peripheral part of a sealing device to the package round an opening in the package, sterilising said package internally through a passage in said peripheral part, filling the package with a product through the passage, and sealing the package in a gas-tight manner by sealing the passage permanently by means of a separate upper part for said sealing device.

The inventive method makes it possible to reduce the “clean room” to comprise only the compartment or volume of the package, which gives great advantages, such as saving in costs and reduced complexity compared with conventional systems where the entire sterilising and filling machine is installed in a clean room environment, or has such an environment. The sterilising and filling machine can thus also be made smaller in terms of volume.

A further advantage of the inventive method is that the peripheral part of the sealing device, which peripheral part may consist of, for instance, the threaded side part of a screw stopper, can be sterilised by the present invention simultaneously with the interior of the package. This makes the entire sealing process easier—for instance the sanitary requirements in connection with transport and sealing are reduced. In this way the production costs can be further reduced by the inventive method.

According to one embodiment of the invention, said step of sterilising said package further comprises the steps of introducing a sterilising gas into the package through said passage, and extracting the sterilising gas by introducing a heavier extraction gas through the passage. This embodiment solves the problem mentioned by way of introduction, i.e. that the sterilising gas, for instance in the form of ozone, can react with the product if the ozone is extracted from the product. Instead the sterilising gas is extracted by means of another heavier gas, which preferably is inert and thus does not react with the product. A heavier gas can also, both before and after filling of the package with the product, stay in the package and act as a lid preventing pollutants from entering.

It will be appreciated that this method of sterilising a package, that is to say by means of a sterilising gas and an extraction gas, is not restricted to sterilisation of packages which are sealed by a sealing device comprising a peripheral part and an upper part, but could also be used for sterilisation of any package. The above advantages of using the extraction gas could thus be used independently of the present invention. A method for sterilisation, filling and sealing of a package could comprise the steps of introducing a sterilising gas into the package, extracting the sterilising gas by introducing a heavier extraction gas into the package, filling the package with a product, and sealing the package in a gas-tight manner.

According to another embodiment of the invention, the method further comprises the step of letting said sterilising gas act for a predetermined time in said package, thus ensuring effective sterilisation of the interior of the package. The predetermined time is preferably between one and ten seconds for a package volume up to 10 litres.

In another embodiment, the method further comprises the step of giving said sterilising gas an overpressure in said package relative to the ambient gas pressure. In this manner, pollutants from the environment can be prevented still more effectively from penetrating into the package while at the same time the sterilising gas is made to penetrate deeper into the package material, and for instance also penetrate deeper between the threads of the peripheral part when this is in the form of a screw stopper.

In one embodiment, said sterilising gas contains ozone. In a further embodiment it contains hydrogen peroxide.

According to another embodiment of the invention, the method further comprises the step of giving said extraction gas an overpressure in said package relative to the ambient gas pressure. Just as mentioned above regarding the sterilising gas, also the extraction gas can in this way still more effectively prevent pollutants from the environment from penetrating into the package.

Said extraction gas contains in one embodiment nitrogen gas, a relatively heavy gas which also is comparatively inert.

In one embodiment of the invention, the method further comprises the step of closing said passage temporarily and partially during said step of internally sterilising said package. This too prevents pollutants from penetrating into the package.

In a further embodiment, the method also comprises the step of sterilising said upper part separately before said step of sealing the package in a gas-tight manner. As a result, the final seal can by means of the upper part be made sterile and at the same time simple.

The step of sterilising the upper part separately comprises according to one embodiment sterilisation of the upper part by means of ozone and/or hydrogen peroxide, both gases being effective for this purpose.

Another aspect of the present invention relates to use of a device according to claim 1 for indicating which product a package holds, wherein said upper part is given a colour and/or shape that allows said indication. As mentioned above, the market requires different colours of seals in order to facilitate differentiation of packaged products. This use of the invention makes it possible to provide differentiation in terms of both colour and shape in a simple way.

### BRIEF DESCRIPTION OF THE DRAWINGS

Currently preferred embodiments of the invention will now be described in more detail with reference to the accompanying drawings, in which

FIG. 1 is a schematic perspective view of a device shown in cross-section for sealing a package according to an embodiment of the present invention, said device comprising a peripheral part and a separate upper part;

FIGS. 2-10 illustrate schematically a method according to an embodiment of the present invention for sterilisation, filling and sealing of a package, in which the device according to FIG. 1 is used;

FIGS. 11-15 schematically show a method according to another embodiment of the present invention for sterilisation, filling and sealing of a package;

FIGS. 16-18 schematically show a method according to yet another embodiment of the present invention for sterilisation, filling and sealing of a package;

FIG. 19 is a schematic perspective view of a device shown in cross-section for sealing of a package according to another embodiment of the invention, said device comprising a peripheral part and a separate upper part;

FIG. 20 is a schematic perspective view of the device in FIG. 19 arranged on a bottle shown in cross-section; and

FIG. 21 is a schematic perspective view of a device for sealing a package according to yet another embodiment of the invention arranged on a package in the form of a can.

### DESCRIPTION OF PREFERRED EMBODIMENTS

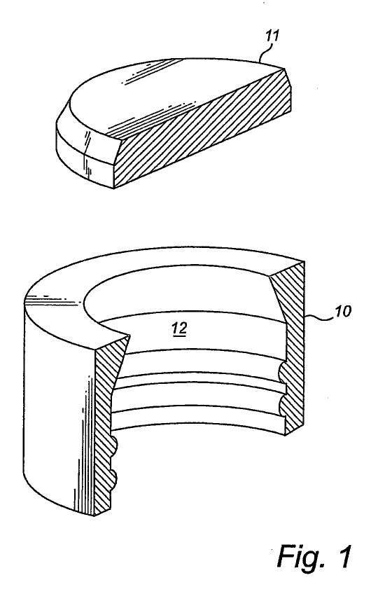

FIG. 1 illustrates an embodiment of a device for sealing a package according to the present invention. The device comprises a peripheral part 10 to be mechanically connected to the package round an opening in the package. The mechanical interconnection is provided in this embodiment by means of threads of the peripheral part which are adapted to run in threads of the package. The device further comprises a separate upper part 11 which is designed to match the peripheral part 10. The peripheral part 10 has a passage 12 which by means of the upper part 11 is sealed in a gas-tight manner when this, for instance by being pressed into the passage 12, is joined to the peripheral part 10. The “gas seal” can possibly be improved, for example, by gluing in, or welding of, the joint between the peripheral part 10 and the upper part 11.

The upper part 11 matches the peripheral part 10 in such a manner that both parts together form a “unit”, in this case in the form of a conventional screw stopper for a bottle. This “unit” can also form a “snap-on cap”, that is to say a cap which, when pressed onto the opening of the package, hooks or “snaps” onto the opening, a lid, a top etc. Examples of packages for which the inventive sealing device can be used are bottles, such as PET bottles or glass bottles, cans such as aluminium cans, cardboard boxes, bags etc.

By means of the passage 12, the package can be sterilised while at the same time the peripheral part 10 is joined to the package round the opening of the package. How this is done will be described in more detail below.

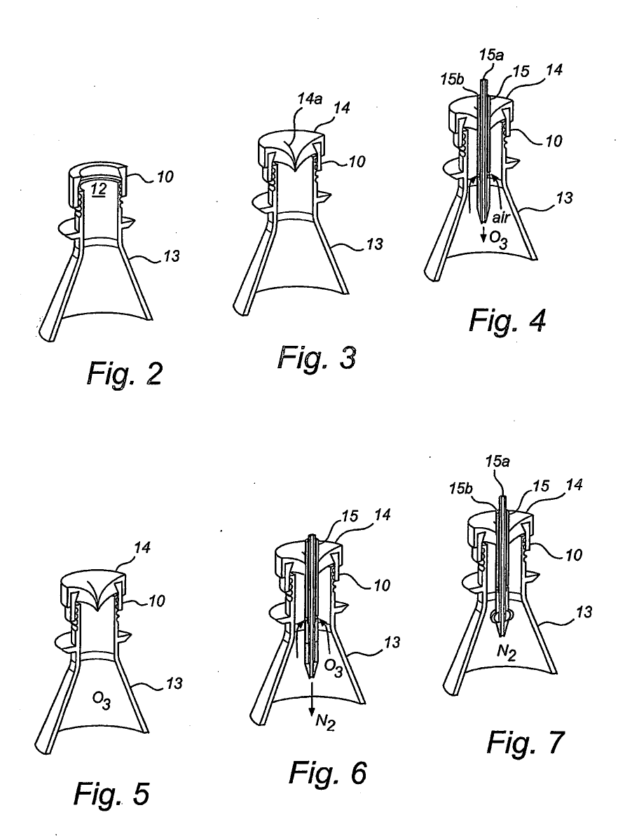

FIGS. 2-10 illustrate step by step a method for sterilisation, filling and sealing of a package according to one embodiment of the invention. The method uses the inventive sealing device, in this case the embodiment of the device as shown in FIG. 1.

FIG. 2 shows in a first step a peripheral part 10 screwed onto a package in the form of a bottle 13. The passage 12 of the peripheral part 10 coincides with the ordinary opening of the bottle 13 so that sterilisation of the interior of the bottle and filling of the bottle with a product can be performed through the passage/opening after fixing the peripheral part 10 to the bottle. The final sealing then occurs by means of the upper part 11, which can be fastened simply by pressure being applied instead of by a more complicated screwing process. This is advantageous since it is difficult to satisfy the sanitary requirements after filling if the final sealing is complicated.

FIG. 3 shows in a second step how a temporary closing means, here in the form of a lid 14 which is form-fit and fits tightly against the peripheral part 10 and has a groove 14a, has been fixed over the upper circular edge of the peripheral part 10. This closing means, which preferably is made of a flexible material, is used for partial closing of the passage 12 during the subsequent internal sterilisation and filling of the package.

FIG. 4 shows in a third step how a tube 15 for sterilisation has been pressed down through the groove 14a of the lid 14. A sterilising gas, here in the form of ozone (O₃), is injected through an inner tube 15a of the tube 15 into the bottle 13, while at the same time the air that was present in the bottle from the beginning is pressed out through an outer tube 15b of the tube 15. In this way, effective sterilisation of the interior of the entire bottle is performed. Instead of, or in combination with, ozone, hydrogen peroxide H₂O₂ or some other suitable gas or gas composition can be used for sterilisation.

FIG. 5 shows how the tube 15 has been removed to allow the sterilising gas to act in the bottle 13 for a while. The flexible groove 14a in the lid 14 then fits relatively tightly so that further pollutants do not enter into the bottle during sterilisation. The time in which the sterilising gas is allowed to act is preferably predetermined to be between one and ten seconds for a bottle volume up to 10 litres, or more preferably between eight and ten seconds. The time is dependent on the volume of the bottle/package—the greater the volume, the longer the time of action.

By the peripheral part 10 of the seal already being connected to the bottle 13 before the internal sterilisation of the bottle, simultaneous sterilisation of part of inside of the peripheral part is performed. In this embodiment, the peripheral part 10 comprises the “thread part” of a cap. The sterilising gas can penetrate between the threads of the bottle 13 and the peripheral part 10 from the inside of the bottle in the opening thereof, down to the point where the threads fit perfectly gas-tight against each other.

The sterilising gas is preferably given a certain overpressure relative to the ambient gas pressure/atmospheric pressure, so that further pollutants from the environment are prevented from penetrating into the bottle 13 during sterilisation. The overpressure also makes it possible for the sterilising gas to penetrate with greater force into the mechanical interconnection, here the threads, between the peripheral part 10 and the bottle 13, thereby ensuring the sterility of the inside of the seal towards the bottle.

FIG. 6 shows how another, or the same, tube 15 has again been pressed down through the groove 14a, this time to introduce a heavier extraction gas into the bottle 13 through the inner tube 15a for extracting the sterilising gas from the bottle through the outer tube 15b. The extraction gas is a relatively heavy gas which is at least heavier than the sterilising gas and preferably also heavier than the ambient air. The extraction gas is advantageously also inert, that is to say not reactive so that any residues of the extraction gas do not react with the product so as to deteriorate the same. The extraction gas contains preferably nitrogen gas (N₂), but some other gas or gas composition, such as carbon dioxide (CO₂), can also be used to extract the sterilising gas.

If the sterilising gas contains ozone, the extracted ozone can advantageously be decomposed by a catalyst (not shown).

By the extraction gas being a relatively heavy gas, it also acts as a temporary seal both before and after filling of the bottle 13 with the product by staying in the bottle as a lid and in this way preventing more or less contaminated air from penetrating into the bottle.

It is preferably ensured that the extraction gas, just like the sterilising gas, has a certain overpressure relative to the ambient gas pressure/atmospheric pressure, so that, from the moment of introducing the extraction gas into the bottle 13, gas is continuously let out of the bottle, whereby it is made still more difficult for ambient pollutants to penetrate into the bottle. After filling the bottle 13 with the product, a certain amount of extraction gas will still stay in the opening of the bottle as a lid over the product, which thus also in the final sealing with the upper part 11 can to some extent prevent contamination.

FIGS. 7 and 8 illustrate the next step of this embodiment of the method, in which the temporary closing means in the form of the lid 14 is removed from the peripheral part 10 and the bottle 13 by the tube 15 being pulled upwards, while at the same time the inner tube 15a is moved upwards in the outer tube 15b so that a ball forms in the lower part of the tube 15. This ball is such as not to force its way through the groove 14a when the tube 15 is pulled upwards, and instead presses the lid 14 upwards and away from the peripheral part 10. After removal of the lid 14, the extraction gas stays in the bottle 13 as a temporary seal as described above to prevent pollutants from penetrating into the bottle.

FIG. 9 shows the next step of the method, in which filling of the bottle 13 with the product through the passage 12 occurs. A filling pipe 16 is moved down through the passage 12, through which filling pipe the product is made to flow. Most of the extraction gas is pressed out by the product through the gap between the peripheral part 10 and the filling pipe 16, but some extraction gas stays in the bottle as an insulating cover over the product in the bottle.

Filling preferably occurs in a clean room environment. The present invention allows use of filling machines that are available on the market. A simpler sterilising machine which operates according to the inventive method and which thus does not need to comprise a clean room environment, can be assembled to the existing filling machine so that the packages immediately after sterilisation enter the clean room environment of the filling machine to be filled.

FIG. 10 shows the last step of the method, in which the bottle 13 is sealed in a gas-tight manner by the passage 12 being permanently sealed by means of the separate upper part 11 of the sealing device. The upper part 11 is joined to the peripheral part 10 in a simple manner by being pressed down over and/or into the passage 12. The sealing can possibly be improved by gluing or welding of the joint between the upper part 11 and the peripheral part 10.

Before the upper part 11 is pressed onto the peripheral part 10 for final sealing of the bottle 13, the upper part is sterilised separately, for instance by means of ozone, hydrogen peroxide, a mixture of these or other gases, plus optionally hot air.

The final sealing of the bottle 13, by applying the upper part 11, preferably also occurs in the clean room environment of the filling machine in order to minimise the risk of contamination. In the cases where it possibly appears difficult to modify, or integrate, a machine for sealing in the filling machine, a separate machine for the final sealing can, however, be arranged in direct connection to the filling machine.

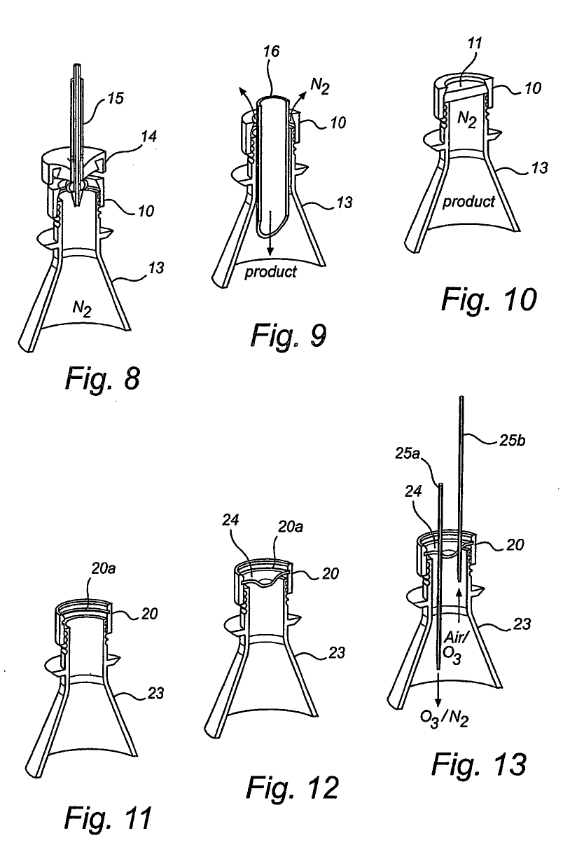

FIGS. 11-15 illustrate more briefly the corresponding steps of another embodiment of a method for sterilisation, filling and sealing of a package. In this embodiment of the method, a slightly different form of sealing device according to the invention is used.

As shown in FIG. 11, the peripheral part 20 of the sealing device has a circular groove 20a for receiving a temporary closing means in the form of a foil 24, either before or after applying the peripheral part 20 to the package, here the bottle 23.

In FIG. 12, the foil 24 is shown to be arranged in the groove 20a, where the foil acts as a temporary closure during sterilisation and filling to prevent ambient pollutants from penetrating into the bottle 23.

FIG. 13 shows how tubes 25a and 25b have been inserted through the foil 24 to supply and extract gases during sterilisation. Like in the previously described embodiment, a sterilising gas, such as ozone, can be supplied in a first step to the bottle 23 through the tube 25a, thereby pressing air out through the tube 25b, and in a second step an extraction gas, such as nitrogen gas, can be supplied through the tube 25a, whereby the sterilising gas is pressed out through the tube 25b.

FIG. 14 shows a filling pipe 26 inserted in the opening of the bottle 23 through the foil 24. A product is supplied through the filling pipe 26 and presses out most of the extraction gas through gaps between the outside of the filling pipe 26 and the foil 24.

FIG. 15 shows how an upper part 21 after filling has been pressed against the peripheral part 20 so that the two parts together form a tight fitting cap, which is intended to be screwed and unscrewed by a consumer. The penetrated foil 24 can be left in the cap, just under the upper part 21, without being a nuisance to the consumer.

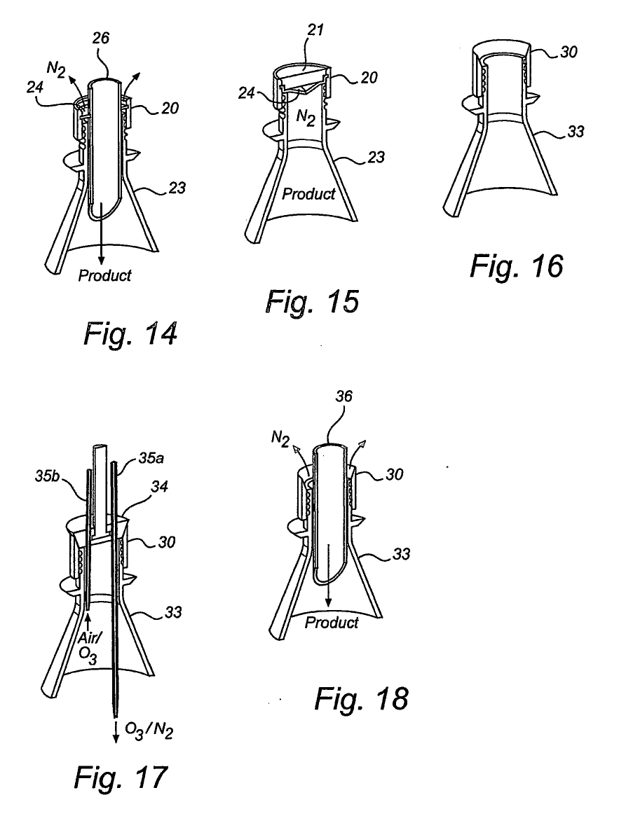

FIGS. 16-18 illustrate still more briefly the corresponding steps according to yet another embodiment of a method for sterilisation, filling and sealing of a package. In this embodiment of the method, use is made of a temporary closing means 34 which is part of a sterilising head of a sterilising machine and which comprises tubes 35a and 35b for supply and extraction of sterilising gas etc.

FIG. 16 illustrates a bottle 33 on which a peripheral part 30 of a sealing device according to an embodiment of the invention is arranged. The peripheral part 30 has a frustoconical upper edge for receiving the temporary closing means 34 and subsequent fitting to an upper part (not shown, but can have a shape corresponding to the shape of the closing means 34).

FIG. 17 illustrates the sterilising head with the temporary closing means 34 and the tubes 35a and 35b for supply of a sterilising gas and, after a while, an extraction gas, and extraction of air and subsequently the sterilising gas.

FIG. 18 illustrates a filling pipe 36 inserted in the opening of the bottle 33 for filling the bottle with a product, after which the bottle is finally sealed by the upper part (not shown) being pressed onto the peripheral part 30.

The method of extracting the sterilising gas by a heavier extraction gas, in order to remove, for instance, residues of the reactive sterilising gas and obtain a protective “gas cover”, can advantageously also be used in sterilisation of a package although the inventive sealing device is not used. A method for sterilisation, filling and sealing of a package may comprise the steps of introducing a sterilising gas into the package, extracting the sterilising gas by introducing a heavier extraction gas into the package, filling the package with a product, and sealing the package in a gas-tight manner. Preferably, the extraction gas is inert. It may contain nitrogen gas, carbon dioxide or some other gas or gas composition, while the sterilising gas may contain ozone, hydrogen peroxide or some other suitable gas or gas composition. The sterilising gas is preferably allowed to act for a predetermined time in the package, which time can be, for example, between one and ten seconds for a package volume up to ten litres. It is preferably ensured that both the sterilising gas and the extraction gas have an overpressure in the package relative to the ambient gas pressure. The opening of the package can advantageously be closed temporarily during sterilisation and filling.

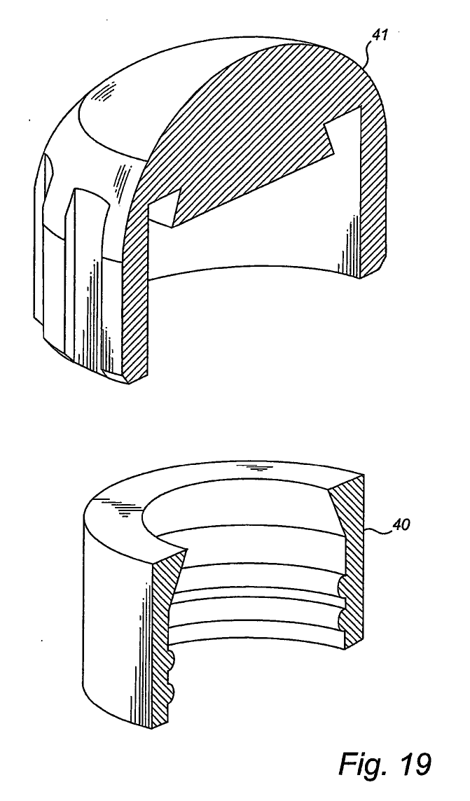

FIG. 19 shows another embodiment of a device for sealing a package according to the present invention. In this device, the peripheral part 40 has the same design as the peripheral part 10 in FIG. 1 while the upper part 41 has a rounded shape that surrounds the peripheral part 40. This is an example of how the upper part of the device can be given a different shape, for instance, in order to differentiate a product on the market from other products. By providing packages for different products with different upper parts, which can differ not only in shape but also in colour, differentiation in terms of shape and colour can be provided by the sealing device although the peripheral part has one and the same appearance for all the different products.

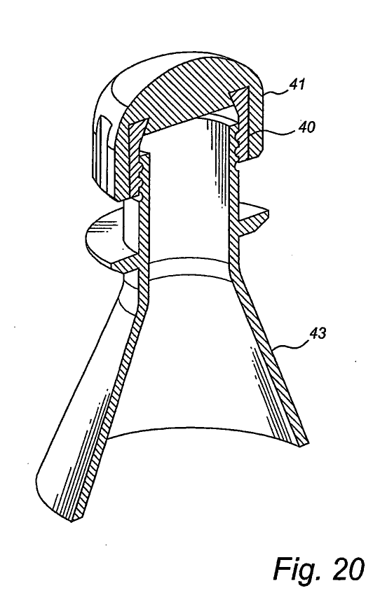

FIG. 20 shows the device in FIG. 19, comprising the peripheral part 40 and the upper part 41, arranged on a bottle 43.

In the above-described examples, the package, for which the inventive sealing device is intended to be used, is of the type PET bottle, but the device, and also the inventive method, is also applicable to other types of packages such as plastic bottles of a different type, glass bottles, cans, cardboard boxes, bags etc.

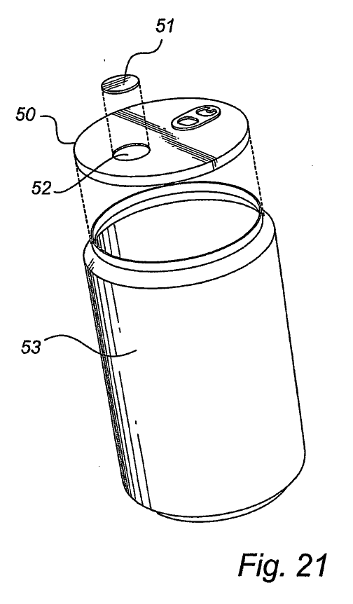

FIG. 21 shows an example of the appearance of an inventive sealing device for a can, such as an aluminium can. In this embodiment, the device comprises a peripheral part 50 with a passage 52, which peripheral part surrounds the upper edge of a cylindrical can 53 and forms a lid for the can 53. An upper part 51 is used to provide a gas-tight final sealing of the passage 52 of the peripheral part 50.

It will be appreciated that modifications of the above-described devices and methods can be made by those skilled in the art, without departing from the spirit and scope of the invention.

1. A device for sealing a package, said device comprising
a peripheral part adapted to be mechanically connected to the package round an opening in the package, said peripheral part comprising a passage for internal sterilisation of the package and filling of the package with a product after connecting the peripheral part to the package, and
a separate upper part for permanent gas-tight sealing of the passage, said upper part being adapted to fit tightly against and form a unit with the peripheral part.

2. A device as claimed in claim 1, wherein said peripheral part comprises a cylindrical part for surrounding an outer partial surface of said package round said opening.

3. A device as claimed in claim 1, wherein said peripheral part comprises threads or a snap means.

4. A device as claimed in claim 1, wherein said peripheral part comprises an upper side for said package, in which upper side a passage is formed for internal sterilisation and filling of the package.

5. A device as claimed in claim 1, wherein said peripheral part is form-fit so as to fit tightly against a closing means for temporary partial closing of said passage during said internal sterilisation of the package.

6. A device as claimed in claim 1, wherein said peripheral part comprises a penetratable foil arranged over said passage.

7. A device as claimed in claim 1, wherein said upper part is made of the same base material as said peripheral part.

8. A device as claimed in claim 1, wherein said upper part is coloured and/or formed to facilitate recognition of said product among other products in similar packages.

9. A device as claimed in claim 1, wherein said package is a bottle or a can

10. A method for sterilisation, filling and sealing of a package, comprising the steps of connecting a peripheral part of a sealing device to the package, round an opening in the package, sterilising said package internally through a passage in said peripheral part, filling the package with a product through the passage, and sealing the package in a gas-tight manner by sealing the passage permanently by means of a separate upper part for said sealing device.

11. A method as claimed in claim 10, wherein said step of sterilising said package further comprises the steps of introducing a sterilising gas into the package through said passage, and extracting the sterilising gas by introducing a heavier extraction gas through the passage.

12. A method as claimed in claim 11, further comprising the step of letting said sterilising gas act for a predetermined time in said package.

13. A method as claimed in claim 12, wherein said predetermined time is between one and ten seconds for a package volume up to ten litres.

14. A method as claimed in claim 11, further comprising the step of giving said sterilising gas an overpressure in said package relative to the ambient gas pressure.

15. A method as claimed in claim 11, wherein said sterilising gas contains ozone and/or hydrogen peroxide.

16. A method as claimed in claim 11, further comprising the step of giving said extraction gas an overpressure in said package relative to the ambient gas pressure.

17. A method as claimed in claim 11, wherein said extraction gas is an inert gas.

18. A method as claimed in claim 11, wherein said extraction gas comprises nitrogen gas.

19. A method as claimed in claim 10, further comprising the step of closing said passage temporarily and partially during said step of internally sterilising said package.

20. A method as claimed in claim 10, further comprising the step of sterilising said upper part separately before said step of sealing the package in a gas-tight manner.

21. A method as claimed in claim 20, wherein said step of sterilising the upper part separately comprises sterilisation of the upper part by means of ozone and/or hydrogen peroxide.

22. The use of a device as claimed in claim 1, for indicating which product a package holds, wherein said separate upper part is given a coulour and/or shape that allows said indication.
